(19) United States
(12) Patent Application Publication
(10) Pub. No.: US 2008/0140370 A1
(43) Pub. Date: Jun. 12, 2008

(54) Multiple Method Identification of Reaction Product Candidates

(76) Inventors: Frank Kuhlmann, Los Altos, CA (US); Frank Wolf, Karlsruhe (DE); Uwe Nassal, Koenigsbach-Stein (DE); Horst Lehmann, Steinau (DE); Edgar Naegele, Karlsruhe (DE)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/567,534

(22) Filed: Dec. 6, 2006

(51) Int. Cl. G06G 7/48

(52) U.S. Cl. 703/11

(57) ABSTRACT

A method of determining a candidate for a product generated by a physical system administered with an educt, the method including determining the candidate for the product based on a combination of a plurality of different procedures for determining the product.

### BACKGROUND

The present invention relates to the identification of chemical reaction products, such as metabolites, degradants and alike.

A liquid chromatography/mass spectrometry instrument (LC/MS) provides molecular weight and structural information about compounds contained in the samples analyzed. These sets of data may support compound identification from one or several runs. Different implementations include standard positive and negative ionization modes, and the use of electrospray ionization (ESI), atmospheric-pressure chemical ionization (APCI) or other ionization method known in the art. This allows the analysis of drugs and drug metabolites, proteins and peptides, pesticides and herbicides, and many other compounds.

Mass spectrometers with analyzers which provide the determination of accurate mass and/or the ability to acquire fragment ion spectra (MS/MS), such as a quadropole time of flight instrument (Q-TOF), are particularly well suited to provide confident structural identification of chemical reaction products such as metabolites. Metabolites are particularly product substances which can be formed by chemical reactions of a substance which has been administered to an organism with reactive substances in the organism. For instance, when a pharmaceutical drug is administered to a human patient, metabolites can be formed via chemical reactions with enzymes and other reactive substances in the human body. The identification of all metabolites formed and their toxicity is crucial in the pharmaceutical drug development. For identifying metabolites, several individual procedures have been developed:

US 2003/0066802 discloses the elucidation of the breakdown of a foreign substance in the metabolism of a liquid, chemical or biological reaction system by the analytical determination of the breakdown products (metabolites) produced. First, a “virtual” breakdown of the foreign substance is calculated, taking into account all the possible branches of the breakdown path according to a set of breakdown rules (so-called biotransformations), which can be determined beforehand, so that the predicted potential breakdown products can be looked for selectively by using a more finally tuned method of measurement.

US 2005/0006576 discloses a programmed computer analyzing data from a mass spectrometer. A fragment ion spectrum corresponding to an unknown sample is perturbed, and each perturbed spectrum is compared with the fragment ion spectrum of a known or reference substance. The perturbed spectrum having the highest correlation with the known spectrum, and which is also physically plausible, is considered to be the best fit. The method indicates in what specific ways the unknown sample differs from, or is similar to, the known substance.

U.S. Pat. No. 5,672,869 and U.S. Pat. No. 6,329,652B describe sample comparison. U.S. Pat. No. 5,672,869 and U.S. Pat. No. 6,329,652B describe an algorithm which allows comparing two LC/MS data sets, typically from a control and a sample, to determine the difference between those two analyses in terms of detectable compounds, which are represented by one or more mass signals which appear at the same retention time in the data set.

### SUMMARY

An objective of the invention is to enable an accurate determination of potential chemical reaction products of a parent compound in a sample. The objective is solved by the independent claims. Further embodiments are described in several dependent claims.

According to an exemplary embodiment of the present invention, a method of determining (for instance identifying) a candidate for a product (for instance a possible/assumed metabolite) generated by a biological system (for instance an organism, like the human body) administered with an educt (for instance a drug) is provided, the method comprising determining the candidate for the product based on a combination of a plurality of (at least two) different (for instance complementary) procedures for determining the product (for instance an actual/real metabolite).

According to another exemplary embodiment, a device (for instance a computer or a computer with a connected liquid chromatography/mass spectrometry system) for determining a candidate for a chemical reaction product formed in an organism administered with an educt is provided, the device comprising a processing unit (like a microprocessor or a central processing unit) adapted to determine the candidate for the product based on a combination of a plurality of different procedures for determining the product.

According to yet another exemplary embodiment, a computer-readable medium (for example a CD, a DVD, a USB stick, a floppy disk or a harddisk) is provided, in which a computer program of determining a candidate for a product generated by a biological system fed with an educt is stored, which computer program, when being executed by a processor (like a microprocessor or a central processing unit), is adapted to control or carry out the above-mentioned method.

According to a further exemplary embodiment, a program element of determining a candidate for a product generated by a physical system fed with an educt is provided, which program element, when being executed by a processor, is adapted to control or carry out the above-mentioned method.

Embodiments of the invention can be partly or entirely embodied or supported by one or more suitable software programs, which can be stored on or otherwise provided by any kind of data carrier, and which might be executed in or by any suitable data processing unit. Software programs or routines can be preferably applied for data processing. The product substance identification scheme according to an exemplary embodiment can be performed by a computer program, i.e. by software, or by using one or more special electronic optimization circuits, i.e. in hardware, or in hybrid form, i.e. by means of software components and hardware components.

The term “product” may particularly denote a result substance which is obtained in a “biological system” like an organism when this system is fed with one or more “educts”, i.e. one or more initial substances.

More particularly, the term “metabolite” may denote a product from an organism which modifies substances. More particularly, it may be a result substance obtained during a metabolic conversion. For example, when a pharmaceutical drug is administered to a (human, animal or plant) body, a metabolite in the body may result from a chemical interaction of the pharmaceutical drug with the organism.

The term “candidate for a product” may denote a possible or expected substance which is reasonably assumed to be a possible product, as a result of a theoretical, semi-theoretical or experimental analysis. Such a candidate may then be considered as an identified product, and in the end, with structural elucidation/assignment, the candidate may be output to the user to be an actual product.

The term “procedure for determining a product” may particularly denote any theoretical model, empiric model, algorithm or experimental data evaluation method, for instance any of the procedures disclosed as such in US 2003/0066802, US 2005/0006576, WO 2005/009039, which is capable of predicting products based on an analysis of theoretical and/or experimental data. The term covers both, presently known procedures for determining a product as well as procedures for determining a product which will be developed in the future. Such a procedure for determining a product may be capable of predicting one or more candidates for the product when being supplied with experimental and/or theoretical information.

The term “combination” may particularly denote any evaluation scheme which is capable of considering a plurality of procedures for determining a product in common. Such an analysis may allow considering the procedures for determining a product on an equal level or with special weightings. Thus, by performing such a combination, the procedures for determining a product are not treated in isolation, but are logically combined to use them synergetically. For example, individual results of individual procedures for determining a product may be combined by a linear combination or any other combination scheme.

According to an exemplary embodiment, the reliability of the estimation of candidates for products may be significantly increased, since the system does not only rely upon a single procedure, but advantageously combines a plurality of different procedures so as to obtain a broader or more reliable basis for the detection of one or more products. By synergistically combining the advantages of a plurality of individual models and by a suppression of their possible weaknesses, the probability that a single method fails in a specific case may be suppressed, since such an exceptional wrong determination may be detected due to a deviation from results obtained by one or more other methods. For instance, averaging procedures may suppress the influence of artifacts in a product detection procedure. For instance, rejecting results of individual methods deviating significantly from agreeing results of multiple other procedures may allow detecting errors in a specific product detection procedure, for instance caused by poor experimental quality. Embodiments are not restricted to metabolite analysis but can be used whenever a parent compound is transferred into product compounds, which somehow hold the parent's signature. Examples are also degradants or impurity analysis, for instance in environmental studies.

According to an exemplary embodiment, multiple procedures may be taken into account simultaneously (for instance in a weighted manner), in order to recognize metabolites. Therefore, exemplary embodiments use different methods in combination for identifying metabolites, so that the final statement with regard to metabolites may be more meaningful. This may allow to rapidly testing metabolic product candidates for a pharmaceutical drug, for example in the context of drug development, design or in clinical trials.

By linking multiple different search algorithms (which, in the context of exemplary embodiments, may be considered as “black boxes” or as procedures being known individually and as such) can be used to find and/or confirm products like metabolites in a biological system like an organism.

Particularly, a scoring scheme may be implemented which may allow to weight the individual or separate procedures. For example, (software) regulators adjustable by control devices (like a computer mouse or a trackball) may be displayed on a screen so that the relevance/weighting of individual procedures may be set by a user. By taking this measure, it may be for instance possible to move the software regulators, for example using a computer mouse and a cursor, so that alterations in the found metabolites and/or their reliabilities can be detected quasi online or quasi in real time based on a direct output of the modified values. Using a scoring or ranking procedure (for example implementing slidable regulators) may allow adjusting or modifying an individual or partial relevance of the individual procedures. When a software regulator is shifted, the modified group of found metabolites can be displayed essentially in real time allowing to verify a scoring, or to analyze a stability of the result.

In the context of such a scoring scheme, it is also possible that an automatic feedback may be given, illustrating the correlation between a metabolite result and previously defined scanning conditions. In this connection, an expert system may be implemented.

Expected metabolites can be identified based on theoretical considerations (for instance based on chemical, physical and/or biological laws or knowledge), based on previous measurements (for instance a correlation between measurements), and/or based on statistical information (like empiric knowledge).

For example, one of these individual search algorithms to be combined according to an exemplary embodiment may be the so-called “isotopic pattern matching”. In the context of isotopic matching, a correlation analysis may be performed to compare the observed isotopic pattern of a product candidate with the theoretical isotopic pattern of a predicted metabolite of known structure (expected metabolites), or the observed isotopic pattern of the educt or precursor compound (unexpected metabolites). The correlation analysis may be conducted on the basis of the observed relative intensities of isotopes to the monoisotopic mass signal. Another embodiment of the correlation analysis may also entail the comparison of the exact mass difference of those isotopes to the monoisotopic mass signal of a product candidate in a sample. However, in contrast to an analysis on the basis of a single procedure, the combination of multiple procedures (for instance a combination of matches by isotopic pattern matching with matches by another procedure like sample comparison and/or fragment pattern matching) may allow to detect metabolites in measurement spectrums with improved accuracy or reliability, since an independent or complementary verification of one procedure may be performed by another procedure.

According to an exemplary embodiment, it is possible to implement a determining method in connection with a measurement apparatus. For instance, a user interface for identifying metabolites using the described combination scheme may be implemented in a liquid chromatography/mass spectrometry system (LC/MS), in which the chromatograph separates the metabolites and a mass spectrometer, preferentially one that provides accurate mass measurements and fragment ion spectra (MS/MS) such as a QTOF, will analyze the metabolites. Then, measurement results collected by the LC/MS may be directly taken as a basis for identifying metabolites. Furthermore, when such an analysis has been performed, the results of the search algorithm may be fed back to the measurement system to automatically control the measurement system and/or to determine lacking measurement values which might allow to confirm or to reject a candidate for a product. When a computer program determines that more measurement results (for instance further fragment ion spectra or MS/MS spectra) are required, then such additional measurements can be acquired by the LC/MS system automatically or after approval by the user.

As already mentioned, one field of application of exemplary embodiments is the identification of drug metabolites. Therefore, dangerous products may be identified (for instance substances in a drug which are toxic or may cause/promote cancer). Another field of application of exemplary embodiments is drug design; when a pharmaceutical drug is administered to a patient, the impact of the pharmaceutical drug on the patient may be investigated. Another field of application of exemplary embodiments is degradation in environment analytics. For example: When a specific substance is introduced into soil, water or air, the interaction of this “educt” with reactive components in the soil, water or air, or the exposure to temperature or UV light may alter the educt and may result in other substances or products which can be identified or analyzed according to exemplary embodiments.

Exemplary embodiments may allow to analyze an experiment so as to determine a probability for a metabolite composition by combining a plurality of procedures like biotransformation (see US 2003/0066802), MS/MS correlation (see US 2005/0006576), isotopic pattern matching (WO 2005/009039), exact mass determination and other tests.

With regard to the linkage or combination of the individual procedures, it is possible that each procedure yields a binary (or “digital”) result (like “identified” or “not-identified”, or “confirmed” or “non-confirmed”, or “qualified ” or “not-qualified”). Alternatively, the system may be refined by making provision that each procedure yields a quantitative (or “analog”) score (like a probability in the range of 0-1 or 0-100% for the detection of a metabolite).

After the determination of the individual binary or analog results of the individual procedures, it is possible to weight the individual results to obtain a weighted (and optionally normalized) “relevance” factor. This weighted product candidate value may be compared to a predetermined or user-defined threshold value (for instance “80%”) to obtain the final result whether a product shall be classified as a product candidate or shall be rejected.

A link of different methods may also be performed in a manner that some of the procedures yield a binary result (for instance EIC, “extracted ion chromatogram”), whereas other procedures yield an analog value (like a probability in the range [0;1]) that the analyzed candidate can be accepted to be a confirmed reaction product.

The system may be implemented as an expert system, so that a user can alter the result (for instance can reject a found metabolite) and can feed back this information or expert evaluation into the system, so that the system calculates an improved or a more realistic scoring. Such expert information can, if desired, be stored as a default value or a constraint for future evaluations.

It is also possible, that the mass spectral information for the determined product candidates (mass, isotopic pattern, fragment ion spectrum) are compared with prestored values in a chemical database in order to identify know metabolites and their potential toxicity.

Next, further exemplary embodiments of the method will be explained. However, these embodiments also apply to the device, to the computer-readable medium and to the program element.

The method may comprise receiving the plurality of procedures via a user interface enabling a user to select the plurality of procedures from a plurality of available procedures for determining the product. Such a user interface may comprise a display device like a cathode ray tube, an LCD device or plasma device. Furthermore, one or more input elements may be provided like a keypad, a joystick, a trackball or even a microphone of a voice recognition system. The user has then the choice, for instance using a computer mouse and a cursor, to select a plurality of supported methods of procedures which shall be taken as a basis for the determination of the product candidates. The user may then select individual procedures, for instance procedures which are desired in the context of a specific scenario or due to preferences of the user. A plurality of such procedures are offered to the user so that the user interface provides the user with a probability to adjust the system to her or his preferences.

The method may comprise outputting information indicating the determined candidate for the product to a user interface. Therefore, the result of the product candidate determination may be displayed visually (on a screen and/or as a hardcopy) and/or acoustically to a user, for example in the form of a list. In such a list, additional information about the identified products (like a confidence level, background information with regard to the identified substance, intermediate calculation results, etc. may be included).

The method may comprise determining the candidate for the product based on data, particularly based on data received via a user interface, indicative of the educt. Information regarding the educt or the educts may be important, since this may enable the system to determine expected chemical reaction products of this or these educts, particularly under specific conditions like temperature, pressure, etc.

It is also possible to determine the candidate for the product based on data, particularly based on data received by a user interface, indicative of the biological system. Different biotransformation schemes may be implemented depending on the organism. If the metabolic system is described (for instance a human being, an animal, a plant, an ecological system, etc.), this information may allow to increase the meaningfulness of the data.

The method may further comprise determining the candidate for the product based on measurement data indicative of a measurement on a sample comprising the educt and/or of a measurement on a sample comprising the product. For instance, a measurement of a mass spectrometer device, a liquid chromatography device, a gel electrophoresis device, radioactivity detector, etc. of a drug and/or of drug metabolites may be taken as a basis for the decision which product candidates are realistic. Thus, the search system may also be coupled to such a measurement device for a unidirectional or bidirectional communication, allowing to refine the measurement and evaluation process.

The method may comprise determining a metabolite of a physiological organism (like a human being, an animal or a plant), a result of a chemical reaction (for instance performed in a specific reaction chamber), or a degradation of an ecological system, for instance chemical processes within a soil or aquatic system (lake, sea, river).

The method may comprise accessing a product candidate determination algorithm database storing a plurality of product candidate determination algorithms assigned to the plurality of different procedures for determining the product. Therefore, the system may have access to previously developed software routines. After having performed an individual evaluation, the individual results may be combined in accordance with a specific combination scheme, for instance by forming some kind of linear combination of the individual results (wherein the linear combination factors may be weighting factors and analog or digital result data obtained from each individual procedure).

The method may comprise accessing an educt database storing educt data. It is also possible to access a product database storing product data. In such a database, a large amount of data may be included which may allow to detect specific parameters (for instance the molecular formula, molecular structure, molecular mass, a biohazard property, etc.) of an educt or a product. Such an educt database may include one or more files (for instance an XML file).

The plurality of different procedures for determining the product may comprise sample-control comparison (see Tozuka Z; Kaneko K; Shiraga T; Mitani Y: Beppu M; Terashita S; Kawamura A; Kagayama A. “Strategy for structural elucidation of drugs and drug metabolites” Journal of Mass Spectrom. 38: 793-808, 2003), isotopic pattern matching (see Cheng K N; Elsom L F; Hawkins D R “Identification of metabolites of halofantrine, a new candidate anti-malarial drug, by gas chromatography-mass spectromety” Journal of Chromatography Biomedical Applications 581 (2): p 203-211, 1992), fragment pattern matching (see Fiori J; Bragieri M; Zanotti M C; Liverani A; Borzatta V; Mancini F; Cavrini V; Andrisano V. “Liquid chromatography-tandem mass spectrometry for the identification of impurities in d-allethrin samples” Journal of Chromatography A 1099 (1-2 ): p 149-156 Dec. 16, 2005), compound search in extracted ion chromatograms (see Paterson S; Cordero R; McCulloch S; Houldsworth P; “Analysis of urine for drugs of abuse using mixed-mode solid-phase extraction and gas chromatography-mass spectrometry” Annals of Clinical Biochemistry 37 (5): p 690-700 September 2000), radioactive label detection (see EMBASE No: 1981020602 “High-pressure liquid chromatography coupled with a radioactivity detector: investigation into the biotransformations of tritium and carbon-14 labeled compounds” Publication Date: 1979), confirmation of compounds via UV absorption (see Jiang Wei; Jin Wenzao; Zhang Yueqin; Wei Yuzhen “Chemical studies on metabolites of an endophytic fungus associated with Taxus cuspidate” Zhongguo Kangshengsu Zazhi 23 (4): p 263-266 1998), biotransformation (see Williams R T; “Detoxification Mechanism: The metabolism and detoxification of drugs, toxic substances and other compounds” 2nd ed.: J. Willey /Sons, Inc. New York 1976), molecular formula assignment (see Fandino A S; Naegele E; Perkins P D. “Automated software-guided identification of new buspirone metabolites using capillary LC coupled to ion trap and TOF mass spectrometry” Journal of Mass Spectrom. 41, 248-255, 2006) and/or molecular structure elucidation (see Fandino A S; Naegele E; Perkins P D. “Automated software-guided identification of new buspirone metabolites using capillary LC coupled to ion trap and TOF mass spectrometry” Journal of Mass Spectrom. 41, 248-255, 2006). Therefore, these or other procedures which work individually may be combined to improve the reliability of the results.

The method may comprise determining the candidate for the product based on a weighting of the plurality of different procedures for determining the product. Corresponding weighting factors may be prestored and/or may be input by a human user so as to bring the search in accordance with her or his specific preferences.

The method may comprise determining the candidate for the product based on data, particularly based on data received by a user interface, indicative of a quantitative rating of a relevance of a part of or of each of the plurality of different procedures for determining the product. For example, one procedure may be particularly specific and reliable, so that this procedure may be assigned to a relatively high weighting factor. Other, less reliable or less appropriate procedures may be assigned to a lower weighting factor, or to a weighting factor of zero.

Particularly, the quantitative rating may comprise a relative rating of one procedure in comparison to another procedure (for instance weighting a first procedure with a value of “12” and a second procedure with a value of “5”). Alternatively, an absolute rating of a procedure may be carried out (so that a sum of the individual weighting factors may be one).

The method may comprise determining the candidate for the product based on data, particularly based on data received by a user interface, indicative of a classification of each procedure. Particularly, the classification may comprise a classification as a procedure for independently identifying the candidate for the product, and a classification as a procedure for confirming or rejecting the candidate for the product identified by another procedure. However, if a procedure does not confirm a metabolite, it does not necessarily mean a rejection. E.g. if a metabolite does not have a chromophor, it will not absorb in UV. Further classifications are possible, like a classification for independently identifying the candidate for the product, but not capable of confirming or rejecting the candidate for the product identified by another procedure. For example, a first group of procedures may be classified to be procedures which may be allowed or authorized to define new candidates for the product. Such methods may also be authorized to confirm or reject a candidate for a product which has been determined beforehand by another procedure. Other (for instance less reliable or less appropriate) procedures may have only the authorization to confirm or reject product candidates which have already been detected beforehand by another procedure. By taking this measure, different levels of reliability of procedures may be implemented in the system, so as to further suppress artifacts.

The method may comprise flagging a candidate for the product to be suspicious in case that one procedure has rejected a candidate for the product which has previously been determined by another procedure. Therefore, an essentially complete list of candidates may be provided, in which suspicious candidates may be highlighted. Then, a user using her or his human skills and expert knowledge may decide whether the suspicious candidate is reliable or not.

The method may comprise calculating a confidence level with which the candidate for the product substance has been determined and accepting the candidate for the product only if the calculated confidence level exceeds a predetermined or user-defined default confidence threshold value. An actual confidence level may be calculated by a linear combination of mathematical products formed by a first factor being the binary or analog result of the candidate determination and a second factor indicating a weighting factor. Then, the default confidence threshold value may be compared to the actual confidence threshold value.

More particularly, such a method may determine an individual binary result by each of the procedures whether or not the respective procedure accepts the candidate for the product. Then, the candidate for the product may be accepted only in case that a number of procedures exceed a (particularly predetermined or user-defined) threshold value accepts the candidate for the product. In this embodiment, only the number of procedures which have determined the candidate for the product are counted. The resulting number is compared to a threshold to determine whether the product candidate may be accepted or not.

Alternatively, an individual probability (for instance having any value between 0 and 1) may be determined by each of the procedures that the respective procedure accepts the candidate for the product. Then, the candidate for the product will be accepted only in case that a cumulated probability exceeds a (particularly predetermined or user-defined) threshold value. Therefore, after having summed up all probability values (if desired in combination with a respective weighting factor) the resulting value is compared to a threshold to determine whether the candidate product may be accepted or not.

The method may comprise receiving data specifying the processing via a graphical user interface (GUI) enabling a data input via a plurality of software regulators. Such software panels or software sliders may allow a user to modify parameters for the determination method so as to be able to monitor modifications of such alterations on the determined candidates. Therefore, the stability of the determination may be monitored and the user-friendliness may be improved.

More particularly, the method may comprise displaying changes with regard to a determined candidate for the product (essentially) in real time upon actuation of at least one of the plurality of software regulators. In other words, by sliding the software regulators, changes of the output will be recognizable immediately.

In the context of the method, a user may be enabled to define a constraint with regard to the determination of the candidate for the product. For example, when the user has expert knowledge (due to previously performed scientific investigations, etc.), a user may, for instance, exclude some products from possible candidate products, for instance if the user knows that these products are, for sure, no appropriate candidates, for instance since this would contradict to natural laws.

The method may comprise enabling the user to define a possible candidate for the product. If the user already has a hint or an indication that a specific product may be part of a sample, the user may input this possible candidate into the system and the system may perform an evaluation whether this prediction is acceptable or not. This may allow to independently confirming a prediction of a

The different procedures may be based on complementary theoretical considerations. By using complementary models for the identification of candidates, measurement artifacts which only have influence on one procedure, but not on the other can be suppressed.

The method may comprise determining a plurality (i.e. two or more) of candidates for the product based on the combination of the plurality of different procedures. Such a plurality of candidates may also be provided in a list, for instance in an order to show first the most probable candidates (having the largest score), followed by less probable candidates (having lower scores). Optionally, at the end of the list, suspicious candidates may be listed. This may allow a user to intuitively recognize which products are relatively probable, and which are more doubtful.

In the following, exemplary embodiments of the device will be explained. However, these embodiments are also applied to the method, to the program element and to the computer-readable medium.

The device may comprise a measurement unit for physically performing a measurement on a sample. The processing unit may then be adapted to determine the candidate for the product based on data received by the measurement. By combining a measurement unit with a candidate search unit which can also give an estimation of product candidates based on the measurement results may allow to provide the user with a user-friendly system.

The device may comprise at least one of the group consisting of a mass spectrometer device, a sensor device, a test device for testing a device under test or a substance, a device for chemical, biological and/or pharmaceutical analysis, an electrophoresis device, a capillary electrophoresis device, a liquid chromatography device, a gas chromatography device, a gel electrophoresis device, a radioactivity detector, and an electronic measurement device. However, any other applications particularly in the field of life science are possible as well.

### BRIEF DESCRIPTION OF DRAWINGS

Other objects and many of the attendant advantages of embodiments of the present invention will be readily appreciated and become better understood by reference to the following more detailed description of embodiments in connection with the accompanied drawings. Features that are substantially or functionally equal or similar will be referred to by the same reference signs.

FIG. 1 shows a device according to an exemplary embodiment.

FIG. 2, FIG. 4 and FIG. 5 show screenshots of a software implementation of a system according to an exemplary embodiment.

FIG. 3 shows a schematic view of a metabolite search system according to an exemplary embodiment.

The illustration in the drawing is schematically.

### DETAILED DESCRIPTION

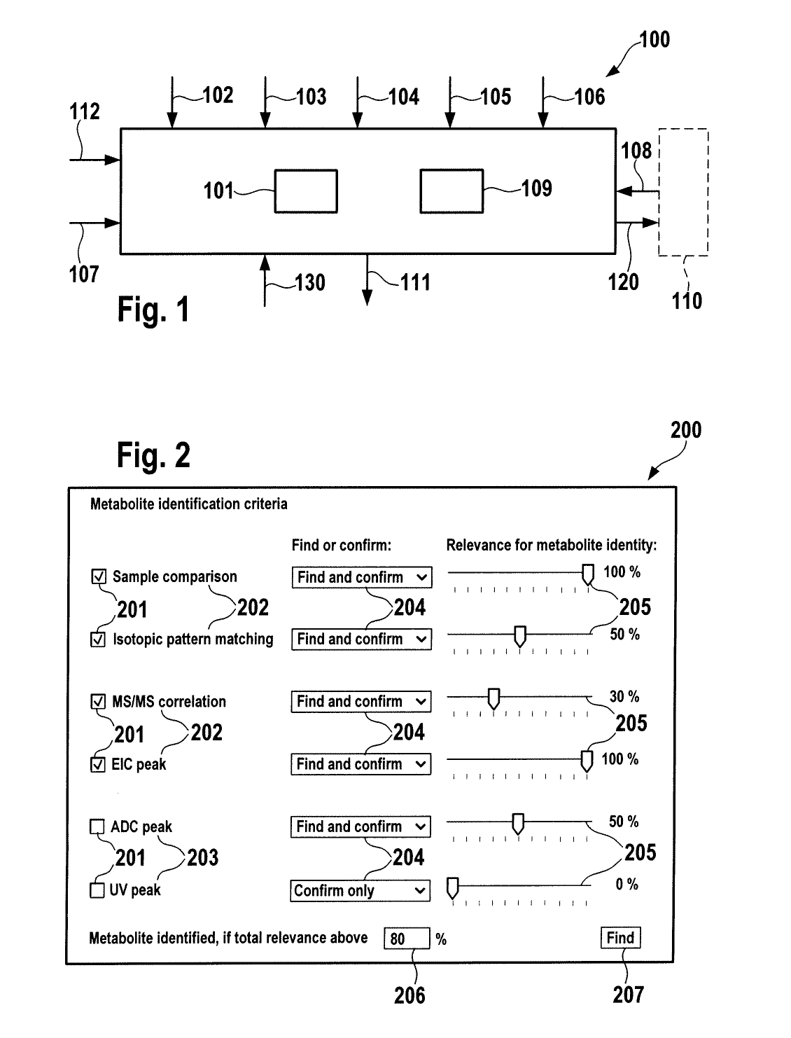

In the following, referring to FIG. 1, a device 100 for determining a candidate for a metabolite generated by an organism administered with a pharmaceutical drug according to an exemplary embodiment of the invention will be explained. Such an organism can be animal, plant or in vitro experiment as well. In an in vitro experiment, the drug may be exposed to a set of enzymes (e.g. from human/animal liver) in a test tube for a defined period of time.

The device 100 comprises a central processing unit (CPU) 101, which may also be denoted as a processing unit or a microprocessor, and which is programmed to determine candidates for the metabolite based on a combination of a plurality of different procedures for determining the metabolites. The device 100 comprises a graphical user interface (GUI).

Via a first input 102, the user may select a plurality of procedures to be used for determining the candidate from a menu which offers a plurality of available processing procedures.

Via an educt interface 103, the user may input information with regard to the educt(s), for example with regard to a pharmaceutical drug and its quantity which is administered to the organism.

A metabolite information input 104 allows a user to provide information with regard to possible metabolites, for instance suggestions for possible candidates which the user may input using her or his expert knowledge.

Furthermore, information with regard to the organism to which the pharmaceutical drug has been administered may be provided via a biological system information input 105. This may include genus, size, weight, known illnesses of the patient, or simply the fact that the “biological system” is a human being.

Threshold values may be input via a threshold input 106. Such a threshold value may be a probability which has to be exceeded to classify a substance as a metabolite candidate.

Furthermore, a user may define constraints for the determination of the candidates for the metabolites, which may be input via a constraint input 107.

Via a weighting/classification input 112, information with regard to a weighting of the individual methods and a classification of the methods may also be input.

The device 100 may be optionally connected to a measurement device 110, for instance a mass spectrometer, including but not limited to a “Quadrupole-Time-of-Flight MS”. Measurement results 108 obtained by the mass spectrometer device 110 may be supplied to the CPU 101 to be used during the analysis of the candidate. Control signals 120 may be supplied from the CPU 101 to the mass spectrometer device 110 to be used during the measurement.

During the analysis, the CPU 101 may also access a database 109 in which a plurality of information may be stored. As a result of the determination, product candidates may be output via an output interface 111. The user may give feedback to this determination by reporting back the output information to the device 100, as indicated by reference numeral 130.

Thus, via the output interface 111, information may be output indicating the determined candidate(s) for the metabolite.

The database 109 may store a plurality of metabolite candidate determination algorithms (like sample comparison, isotopic pattern matching, fragment pattern matching, compound search in extracted ion chromatograms, radioactive label detection, compound confirmation in UV chromatograms, biotransformation, molecular formula assignment) which may be used for the analysis.

FIG. 2 shows a screenshot 200 of a software implementation of an automated metabolite search system according to an exemplary embodiment.

Using selection fields 201, a user may, using a computer mouse and a cursor, define selected procedures 202 which are selected for a subsequent determination, and define non-selected procedures 203 which are disregarded for a subsequent determination.

Further, a classification (“find and confirm” or “confirm only”) may be defined via classification fields 204.

Via software regulators 205, the individual relevance of a respective procedure for the metabolite identification may be defined by a user.

Furthermore, via an input field 206, a confidence threshold value may be defined indicating that a metabolite is identified when the total relevance of the selected methods 202 exceeds, in the present example,“80%”.

By clicking on a “find” button 207, the metabolite search method may be started.

FIG. 2 therefore shows a metabolite identification software method set up for the metabolite identification criteria. With the push of one button 207, the software will evaluate the data based on a specific set of algorithms. The algorithms are used to find a metabolite candidate or to only confirm an existing metabolite candidate. The algorithms are ranked according to their relevance. The total relevance of a metabolite candidate may be a combination of the algorithms that are confirming the metabolite candidate and the individual relevancies. If the total relevance exceeds the threshold, then the metabolite candidate is labeled as an identified metabolite.

All find and confirm qualifiers may be seen as an identification qualifier, which means: If a compound has not been classified as a metabolite by sample comparison, but if it appears to be a metabolite by any other procedure, for instance by isotopic pattern matching, then a new row will be added to the metabolite table: A “qualified by sample comparison” column state will be “No”. A “qualified by isotopic pattern” column state will be “Yes”. If isotopic pattern matching (and other confirmation qualifiers) are seen just as confirmation criteria, then the “qualified by isotopic pattern” column would be set for the already available metabolites in the table. But it may be possible to add metabolites retrospectively, if they are classified by at least one other criterion.

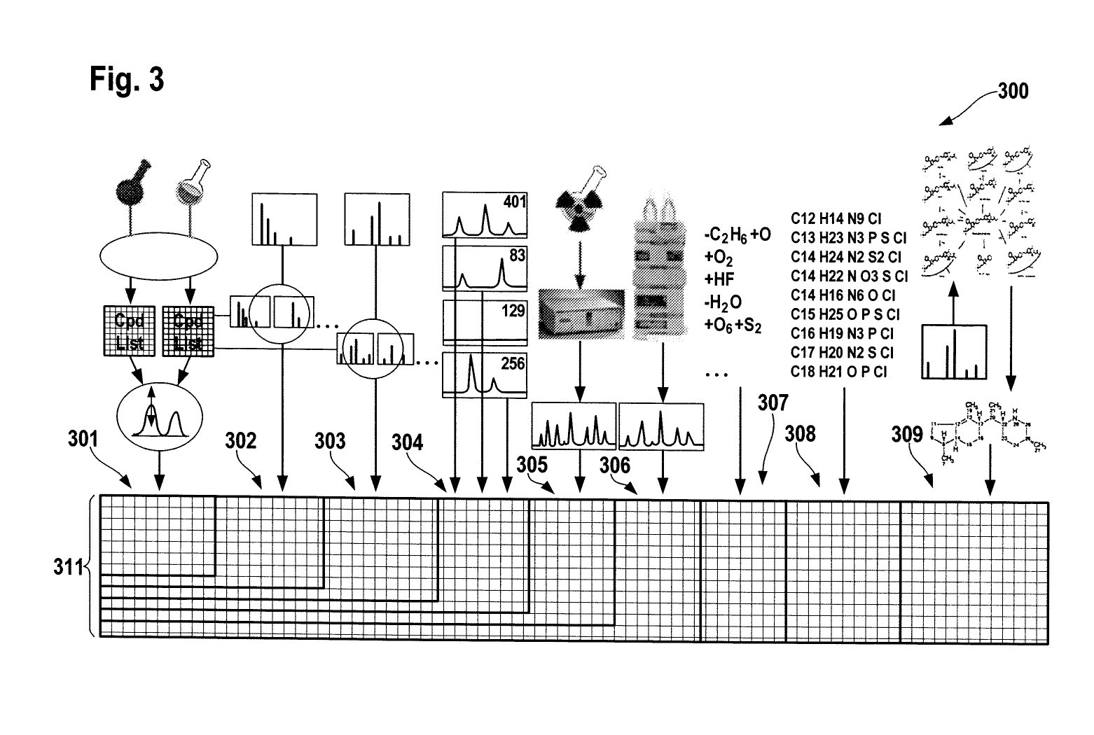

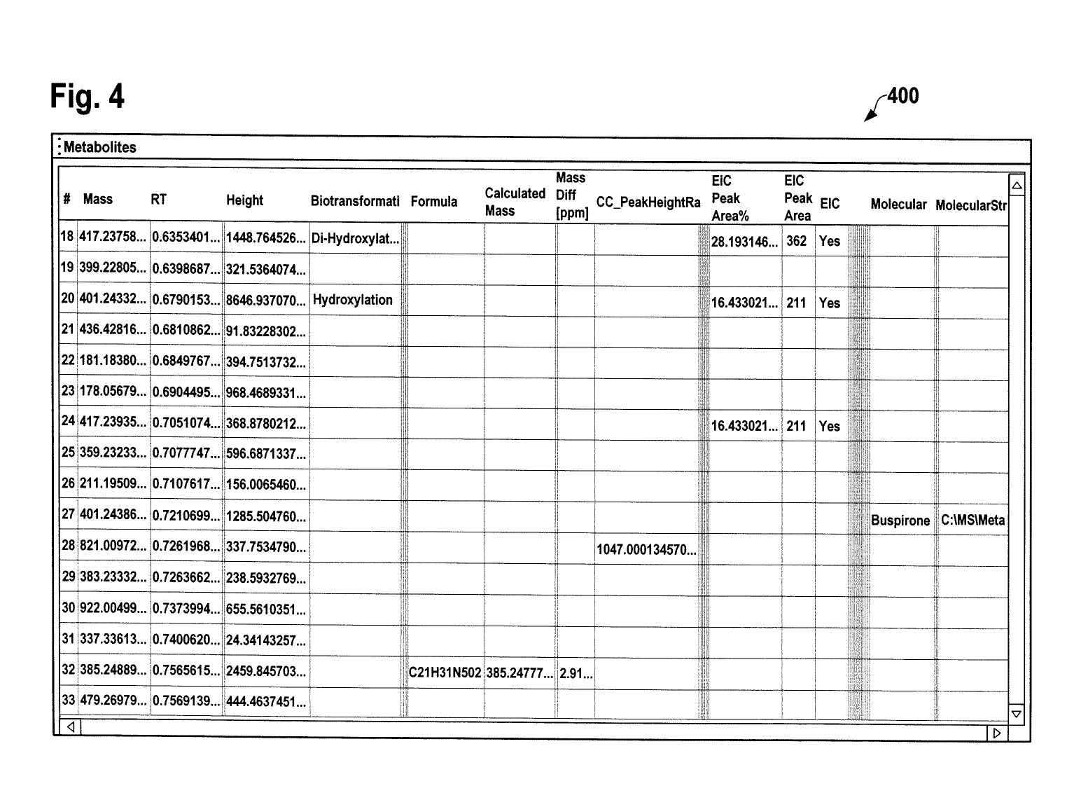

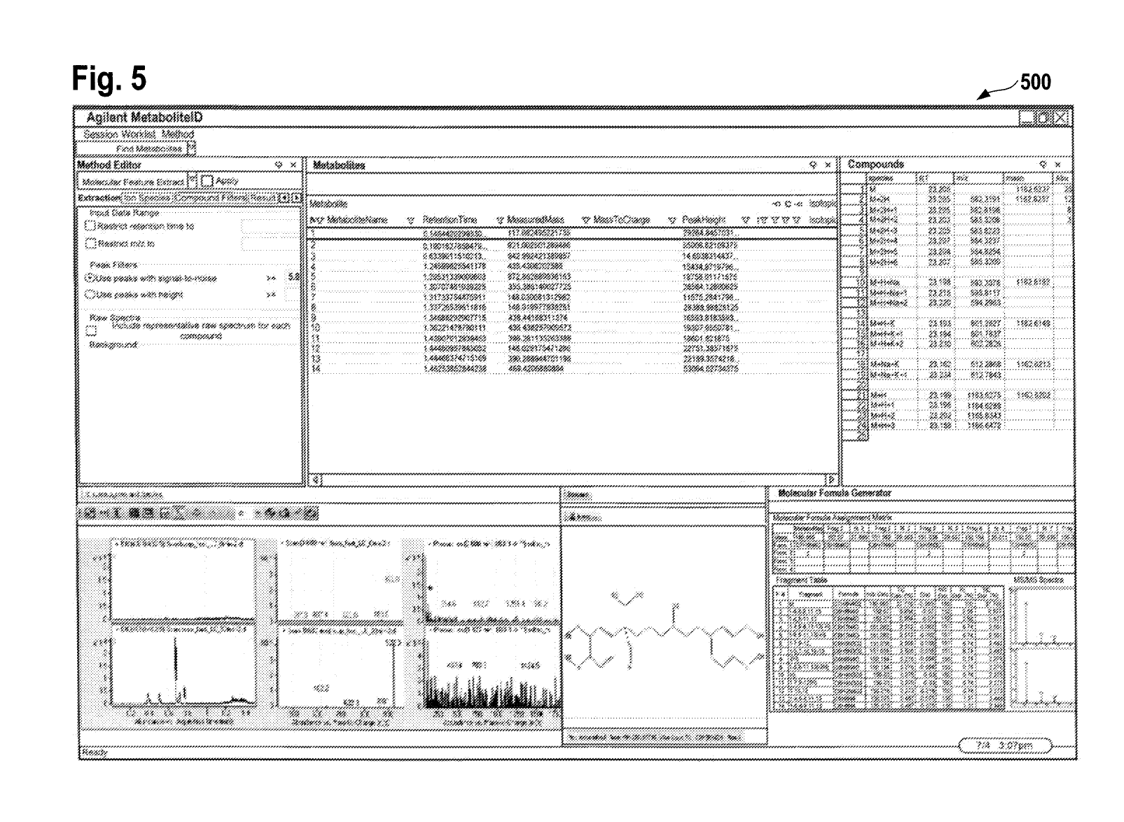

FIG. 3 shows a metabolite identification workflow 300, using a find and confirm strategy.

A plurality of different procedures 301 to 308 are mentioned, namely sample comparison 301, isotopic pattern matching 302, fragment pattern matching (or MS/MS correlation) 303, compound search in EIC (extracted ion chromatogram) of expected masses 304, compound search in RAD (radioactivity) chromatograms 305, confirmation of a metabolite via UV absorption 306, biotransformation 307 molecular formula assignment 308 and molecular structure elucidation 309. A table of identified metabolites 311 is shown as well. To find a new metabolite candidate, a row is added to the table 311. To confirm an existing metabolite candidate, columns are added to the table 311.

In a sample comparison scheme 301, a sample may be compared at a time t=0 and at a time t>0 (when the sample is already metabolized partially or completely). For this purpose, mass spectrometry signals may be used.

The isotopic pattern matching procedure 302 may be based on the effect that an isotopic pattern of initial substances should be found in a correlated manner in the products.

Fragment pattern matching 303 may correlate a fragment ion (MS/MS) spectrum of a drug with the fragment ion spectrum of a potential metabolite.

Compound search in EIC (extracted ion chromatograms) 304 of expected masses may be based on the assumption of a mass shifts induced by specific biotransformation reactions. Thus, if such mass shifts are detected, a metabolite may be identified.

Compound search in RAD chromatograms 305 may be based on the detection of radioactive labels.

Compound confirmation in UV chromatograms 306 may be based on an UV detector configured in parallel or in serial to a mass spectrometer for metabolites which exhibit a chromophor.

Molecular formula assignment 308 may be based on the assumption that only one elemental composition fits to the measured accurate mass of the product and that subsets of the same elemental composition must explain the product fragment masses and their neutral losses in the MSMS spectrum.

Molecular structure elucidation 309 may be based on the assignment of selected or predicted molecular structures, which fragmentation pattern matches the product MSMS spectrum.

FIG. 4 shows a table 400 in which a plurality of identified metabolites are listed.

FIG. 5 shows a screenshot 500 on which a plurality of information with regard to metabolite identification is shown.

It should be noted that the term “comprising” does not exclude other elements or features and the “a” or “an” does not exclude a plurality. Also elements described in association with different embodiments may be combined. It should also be noted that reference signs in the claims shall not be construed as limiting the scope of the claims.

What is claimed is:

1. A method of determining a candidate for a product generated by a biological system administered with an educt, particularly a pharmaceutical drug, the method comprising
determining the candidate for the product based on a combination of a plurality of different procedures for determining the product.

2. The method of claim 1, comprising receiving a selection of the plurality of procedures via a user interface enabling a user to select the plurality of procedures from a plurality of available procedures for determining the product.

3. The method of claim 1, comprising determining the candidate for the product based on a weighting of the plurality of different procedures for determining the product.

4. The method of claim 1, comprising determining the candidate for the product based on data, particularly based on data received by a user interface, indicative of a quantitative rating of a relevance of each of the plurality of different procedures for determining the product.

5. The method of claim 4, wherein the quantitative rating comprises one of the group consisting of a relative rating of one procedure in comparison to another procedure, and an absolute rating of a procedure.

6. The method of claim 1, comprising determining the candidate for the product based on data, particularly based on data received by a user interface, indicative of a classification of each procedure.

7. The method of claim 6, wherein the classification comprises at least one of the group consisting of a classification as a procedure for independently identifying the candidate for the product, and a classification as a procedure for confirming or rejecting the candidate for the product identified by another procedure.

8. The method of claim 7, comprising flagging a candidate for the product to be suspicious in case that one procedure has rejected a candidate for the product which has been previously determined by another procedure.

9. The method of claim 1, comprising:
determining an individual binary result by each of the procedures whether or not the respective procedure accepts the candidate for the product, and accepting the candidate for the product in case that a number of procedures exceeding a, particularly predetermined or user-defined, threshold value accepts the candidate for the product;

10. The method of claim 1, comprising:
determining an individual probability by each of the procedures that the respective procedure accepts the candidate for the product, and accepting the candidate for the product in case that a cumulated probability that the candidate for the product is accepted exceeds a, particularly predetermined or user-defined, threshold value.

11. The method of claim 1, comprising receiving data specifying the processing via a graphical user interface enabling a data input via a plurality of software regulators.

12. The method of claim 11, comprising displaying changes with regard to a determined candidate for the product in real time upon actuation of at least one of the plurality of software regulators.

13. The method of claim 1, comprising at least one of:
outputting information indicating the determined candidate for the product to a user interface;
determining the candidate for the product based on data, particularly based on data received via a user interface, indicative of the educt;
determining the candidate for the product based on data, particularly based on data received by a user interface, indicative of the physical system;
determining the candidate for the product based on measurement data indicative of at least one of the group consisting of a measurement on a sample comprising the educt, and a measurement on a sample comprising the product;
determining one of the group consisting of a metabolite of a physiological organism, a result of a chemical reaction, and a degradation in an ecological system.

14. The method of claim 1, comprising at least one of:
accessing a product candidate determination algorithm database storing a plurality of product candidate determination algorithms assigned to the plurality of different procedures for determining the product;
accessing an educt database storing educt data.

15. The method of claim 1, wherein:
the plurality of different procedures for determining the product comprises at least one of the group consisting of sample comparison, isotopic pattern matching, fragment pattern matching, compound search in extracted ion chromatograms, radioactive label detection, compound search in UV chromatograms, biotransformation (307), molecular formula assignment, and molecular structure elucidation.

16. The method of claim 1, comprising at least one of:
calculating a confidence level with which the candidate for the product has been determined and accepting the candidate for the product only if the calculated confidence level exceeds a, particularly predetermined or user-defined, confidence threshold value;
enabling a user to define a constraint with regard to the determination of the candidate for the product;
enabling a user to define a possible candidate for the product;
determining the candidate for the product based on an in vitro experiment;
determining the candidate for the product by performing a plurality of iterations and by enabling a user to influence the determination between subsequent iterations;
the different procedures are based on complementary theoretical considerations;
the different procedures are different product candidate determination algorithms;
determining a plurality of candidates for the product based on the combination of the plurality of different procedures.

17. A computer-readable medium, in which a computer program of determining a candidate for a product generated by a biological system administered with an educt is stored, which computer program, when being executed by a processor, is adapted to control or carry out a method of claim 1.

18. A program element of determining a candidate for a product generated by a physical system administered with an educt, which program element, when being executed by a processor, is adapted to control or carry out a method of claim 1.

19. A device for determining a candidate for a product generated by a physical system fed with an educt, the device comprising a processing unit adapted to determine the candidate for the product based on a combination of a plurality of different procedures for determining the product.

20. The device of claim 19, comprising at least one of the following features:
the device comprises a measurement unit for physically performing a measurement on a sample, wherein the processing unit is adapted to determine the candidate for the product based on data received by the measurement unit;
the device comprises at least one of the group consisting of a mass spectrometer device, a sensor device, a test device for testing a device under test or a substance, a device for chemical, biological and/or pharmaceutical analysis, an electrophoresis device, a capillary electrophoresis device, a liquid chromatography device, a gas chromatography device, a gel electrophoresis device, a radioactivity detector, and an electronic measurement device.
